(19) United States
(12) Patent Application Publication
(10) Pub. No.: US 2008/0149009 A1
(43) Pub. Date: Jun. 26, 2008

(54) Reversible safe door

(75) Inventor: James A. Boyes, Blairgowrie (GB)

Correspondence Address: MICHAEL CHAN;NCR CORPORATION, 1700 SOUTH PATTERSON BLVD, DAYTON, OH, 45479-0001, US

(73) Assignee: NCR Corporation

(21) Appl. No.: 11/642,096

(22) Filed: Dec. 20, 2006

(51) Int. Cl. E06B 3/34

(52) U.S. Cl. 109/73

(57) ABSTRACT

A safe having a door configurable to open to the left or the right. The safe having hinge parts configurable to form a hinge at either the left or the right of the door. The configuration of the door being performed in a manner which allows a single person to perform the configuration without the need to support the weight of the door.

### TECHNICAL FIELD

The present invention relates to a reversible safe door. It is particularly related to, but in no way limited to, a reversible safe door for an Automated Teller Machine (ATM).

### BACKGROUND

Automated Teller Machines (ATMs) store a relatively large sum of money for dispensing to customers, or that has been deposited by customers for collection by a financial institution. A safe is provided as part of ATMs to store the currency in a secure manner. The safe has an access mechanism which allows removal and deposit of currency by the ATM, but prevents access by unauthorized persons, for example people attempting to steal the currency.

The safe must also provide access for security personnel to replenish the stock of currency and remove deposited currency. That access is conventionally provided via a standard safe-door design, incorporating a suitable locking mechanism. The purpose of the safe is to prevent access to the content of it by unauthorized persons and therefore safes are constructed of very strong and consequently heavy material. In particular, the door and associated locking and hinge mechanisms are sufficiently strong to withstand attack making them very heavy.

Currency is stored in the safe in cassettes which are of a substantial size, and relatively unobstructed access is therefore required to the safe in order to replenish it. ATMs must therefore be positioned such that sufficient access is provided for replenishment. However, a consideration in ATM location is that the position is suitable for customer use and it is undesirable to compromise that position to allow sufficient access to the safe for replenishment. Another factor which may affect placement of an ATM is security considerations. Some financial institutions have security policies which require an ATM to be placed in close proximity to 2 walls, as this offers improved protection to an attack on the ATM. A particular problem arises due to the fact that safe doors are relatively thick, and therefore to provide sufficient access to the safe the door must open by more than 90°. If a safe is mounted close to a wall, the door can therefore only open sufficiently if it opens away from the wall. Furthermore, there may be other obstacles in the area of the safe door that requires it to open in a particular direction to permit replenishment. A safe whose door opens in the correct direction must therefore be ordered for each installation, thus requiring prior consideration of the location of the ATM and the correct ordering and delivery of the equipment.

The requirement to select and order a specific variety of safe is inconvenient as it adds cost and complexity to the installation process and furthermore requires two designs of safe to be manufactured.

There is therefore a requirement for a safe for use with an ATM which allows sufficient access to the safe, while not imparting any particular requirements on the positioning of the safe.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

There is provided a safe, comprising a safe body having a door opening and hinge parts located on two opposite sides of that door opening, a safe door having hinge parts on two opposite sides of the door, the hinge parts of the safe body being pivotably connectable to respective hinge parts of the safe door, wherein the safe door can be configured to pivot open in two different directions by appropriate connection of the hinge parts.

The safe may further comprise a mechanism to retain the safe door in a closed position. The mechanism may be a locking mechanism.

The safe may further comprise hinge pins to connect respective hinge parts on one side of the safe door and body. The hinge pins may be removable. The hinge pins may be secured in the hinge parts.

The safe may be configured for use in conjunction with an Automated Teller Machine.

There is also provided a method of reconfiguring the direction of opening of a safe door, comprising the steps of securing the safe door in a closed position, connecting hinge parts on a first side of the door to form a hinge, and disconnecting hinge parts on a second side of the door.

The hinge parts may be connected by inserting a hinge pin.

The hinge pins may be secured in the hinge parts.

The method may further comprise the step of unsecuring the safe door.

Prior to application of the method the safe door may pivot open in a first direction, and after application of the method, the safe door may pivot open in a second direction.

The method may further comprise the step of disconnecting an alarm harness prior to securing the door in the closed position.

The method may further comprise the step of connecting an alarm harness after unsecuring the safe door.

Many of the attendant features will be more readily appreciated as the same becomes better understood by reference to the following detailed description considered in connection with the accompanying drawings. The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawing, in which:

FIG. 1 is a plan of a typical ATM installation;

FIG. 2 is a perspective view of an embodiment of the invention with the door configured to open to the right;

FIG. 3 is a perspective view of an embodiment of the invention with the door configured to open to the left;

FIG. 4 is a perspective view of an embodiment of the invention with the door configured to open to the right;

FIG. 5 is a perspective view of an embodiment of the invention with the door closed and showing hinge pins to be inserted;

FIG. 6 is a perspective view of an embodiment of the invention with the door closed and showing hinge pins after removal; and

FIG. 7 is a perspective view of an embodiment of the invention with the door configured to open to the left.

### DETAILED DESCRIPTION

Embodiments of the present invention are described below by way of example only. These examples represent the best ways of putting the invention into practice that are currently known to the Applicant although they are not the only ways in which this could be achieved.

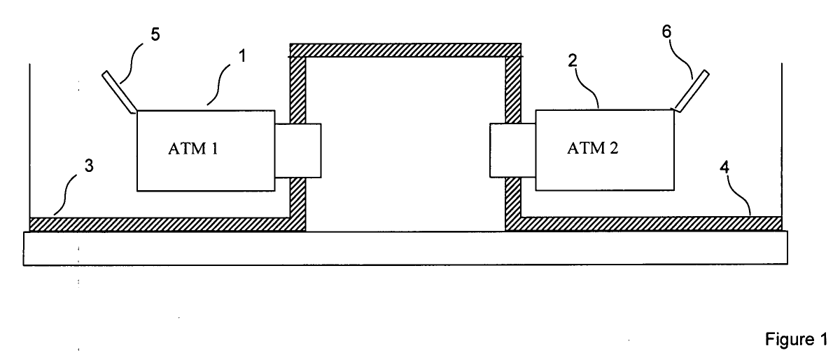

FIG. 1 shows an ATM installation of two ATMs 1,2. Each of the ATMs 1,2 is positioned close to a wall 3,4 that prevents opening of the safe door sufficiently in that direction to allow replenishment. For ATM 1 the door 5 must therefore be hinged on the left, and for ATM 2 the door 6 must be hinged on the right. In order to complete this installation two different safes would therefore be required.

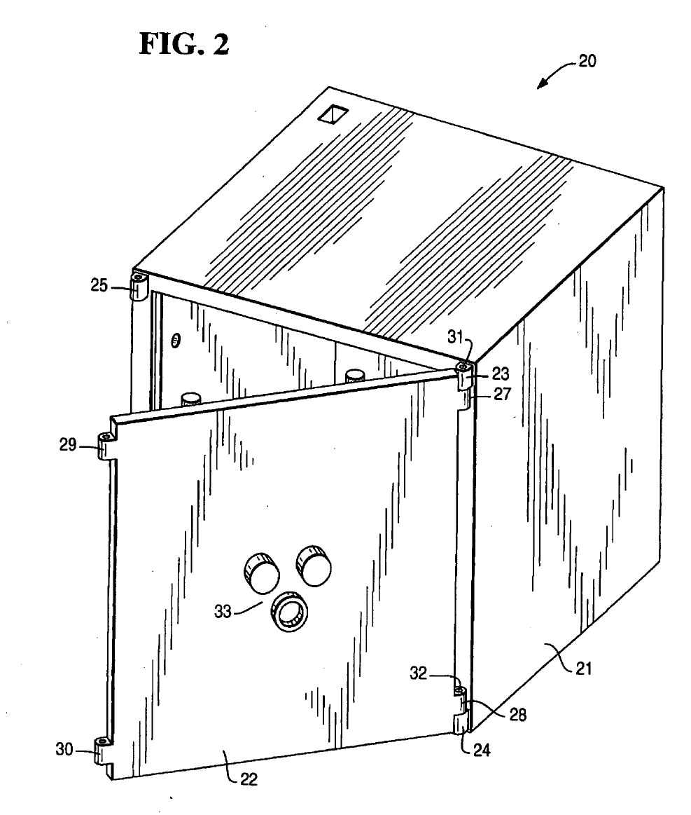

FIG. 2 shows a safe which solves the problem of providing a safe that can be accessed when there are obstructions that prevent opening of the door in a particular direction. The safe enables the door to be configured to open to either the left or the right, and for the direction of opening to be configured during installation.

Safe 20 has a body part 21 and a door part 22. The body 21 has hinge parts at the right 23, 24 and the left 25, 26 (not visible in FIG. 2), and the door 22 has respective hinge parts 27, 28, 29, 30. Each of the hinge parts is configurable to form a hinge with a respective other hinge part. A hinge is formed from respective hinge parts by the insertion of a pin through the parts such that the door 22 can pivot relative to the body 21 around the pin. As shown in FIG. 2, pins 31, 32 are inserted into hinge parts 23, 27 and 24, 28 to form hinges at the right of the door 22. No pins are inserted into the hinge parts 25, 26, 29, 30 on the left side of the door 22 and consequently that side is free to move. The door 22 is therefore configured to open to the right.

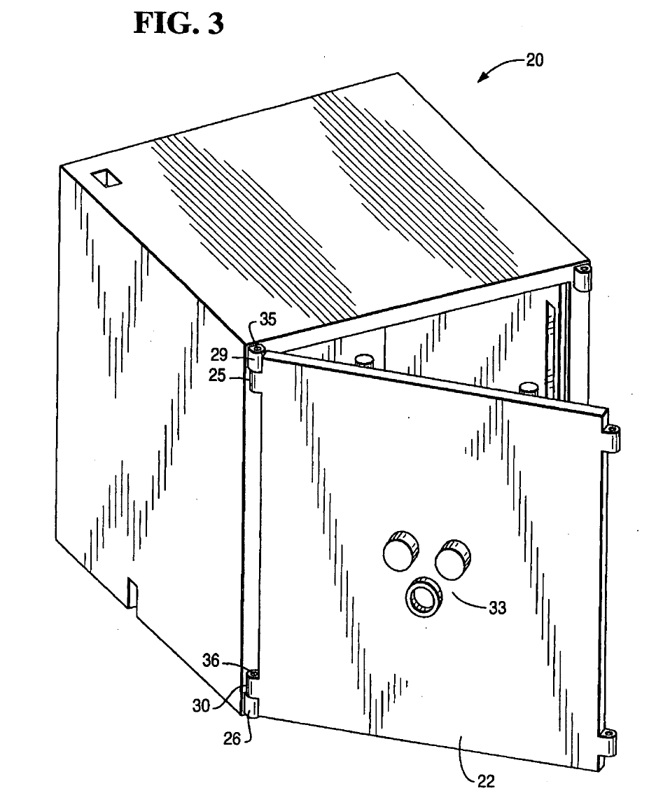

FIG. 3 shows the safe of FIG. 2, but with the door configured to open to the left. Hinge pins 35, 36 are inserted into hinge parts 29, 25 and 26, 30 to form hinges at the left of the door 22. No pins are inserted into hinge parts 23, 27, 24, 28 on the right side of the door and consequently that side is free to move.

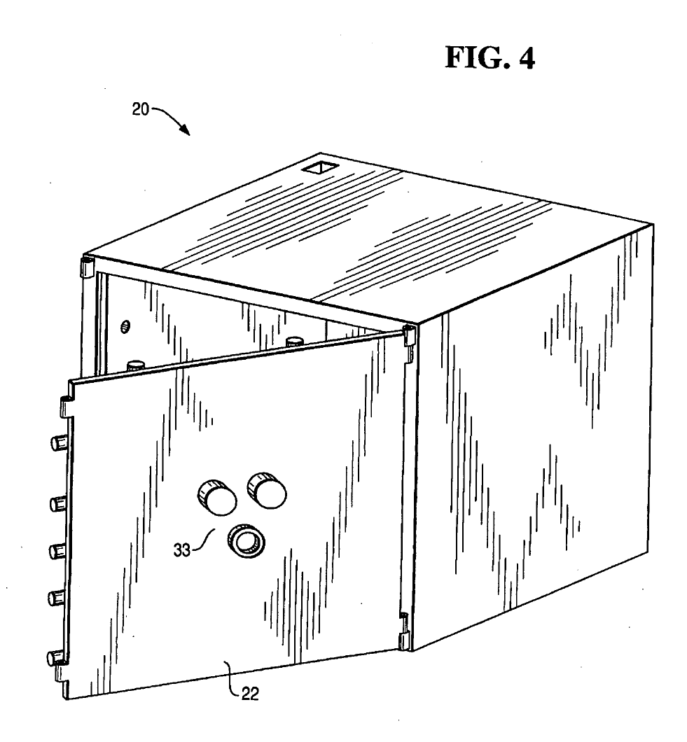

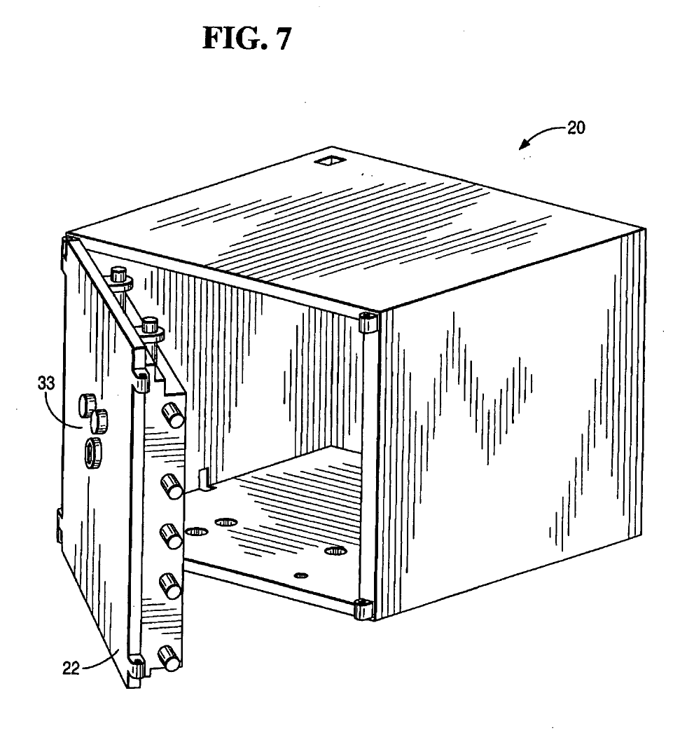

FIGS. 4 to 7 are a series of figures showing the safe door being converted from opening to the right (FIG. 4) to opening to the left (FIG. 7).

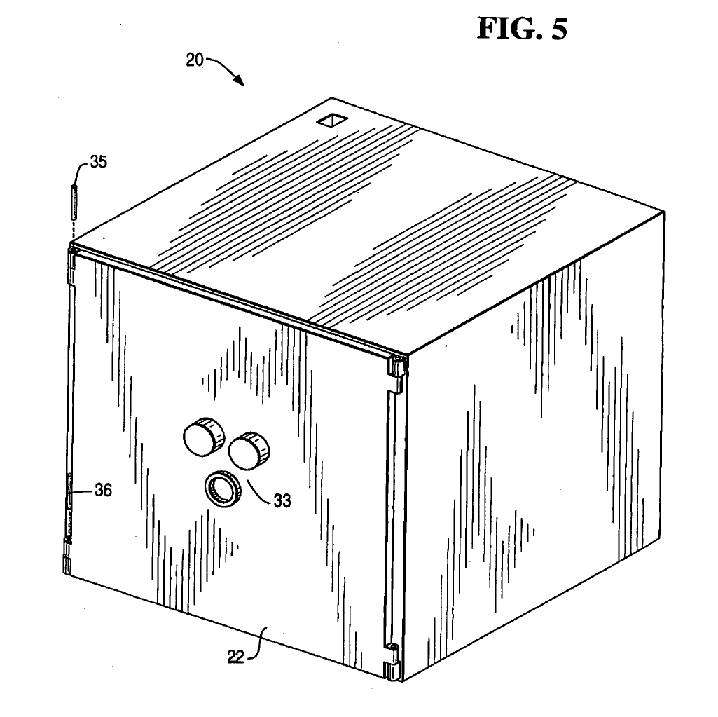

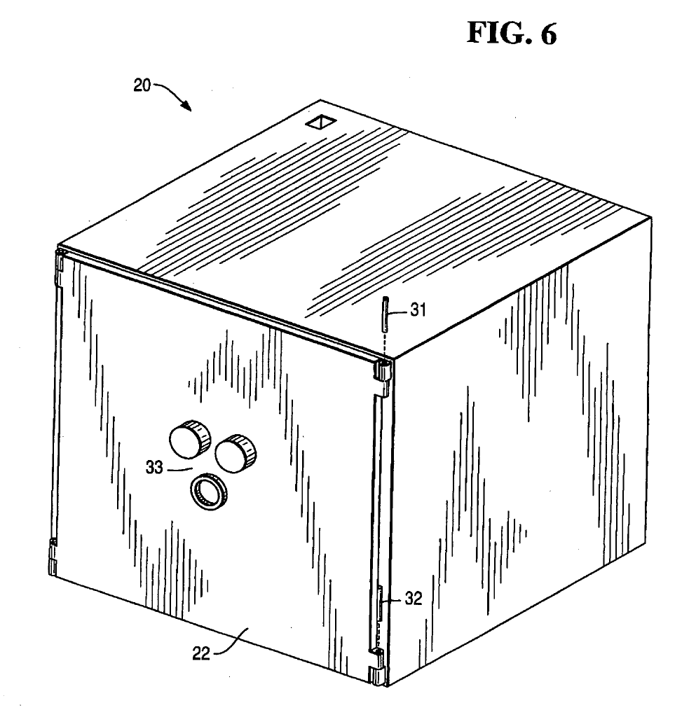

To convert the side of opening, the safe door is closed and secured in that position (FIG. 5). The safe's locking mechanism may be utilized to secure the door, or an additional mechanism may be provided to retain the door in position during the process. Hinge pins 35, 36 are inserted into the hinge parts to the left of the door to form hinges at the left of the door. The pins may be secured in position, for example by screwing them into the hinge parts. Hinge pins 31, 32 are then removed (FIG. 6) from the hinge parts to the right of the door to free that side of the door. The door is then free to open to the left (FIG. 7).

The safe allows conversion of the direction of opening of the door without the need to support the weight of the door, as must be done with prior art designs. Such support is not possible in the present application of the safe since there are insufficient people and equipment present during ATM installation to support the door.

The safe may be equipped with an alarm system having cabling connecting the door and the safe body. Connections for the cabling may be provided at both the left and right sides and the appropriate connections utilized depending upon the selected door opening direction. The cabling may be disconnected prior to changing the direction of opening and reconnected at the other side after the change has been completed.

As will be apparent to the person skilled in the art, the number of hinges on each side of the safe may be selected dependent upon the size or other characteristics of the safe.

The hinge parts have been described herein as being configured as hinges by the insertion of hinge pins to connect those parts. As will be apparent to the person skilled in the art other methods of forming hinges between parts may be employed. For example moveable parts may be provided as part of the hinge parts to pivotably connect respective hinge parts to form a hinge.

Any range or device value given herein may be extended or altered without losing the effect sought, as will be apparent to the skilled person.

It will be understood that the benefits and advantages described above may relate to one embodiment or may relate to several embodiments. It will further be understood that reference to ‘an’ item refer to one or more of those items.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A safe, comprising
a safe body having a door opening and hinge parts located on two opposite sides of that door opening,
a safe door having hinge parts on two opposite sides of the door, the hinge parts of the safe body being pivotably connectable to respective hinge parts of the safe door, wherein
the safe door is configured to pivot open in two different directions by appropriate connection of the hinge parts by insertion of securing elements securing hinge parts on one side of the door opening and one side of the door, and removal of securing elements securing hinge parts on the other side of the door opening and the other side of the door, the safe door including a mechanism for securing the door in a change of configuration of position in which the weight of the safe door will be borne by the safe body during changing of the securing elements.

2. A safe as claimed in claim 1, wherein the mechanism retains the safe door in a closed position.

3. A safe as claimed in claim 2, wherein the mechanism is a locking mechanism.

4. A safe as claimed in claim 1, further comprising hinge pins connecting respective hinge parts on one side of the safe door and body.

5. A safe as claimed in claim 4, wherein the hinge pins are removable.

6. A safe as claimed in claim 4, wherein the hinge pins are secured in the hinge parts.

7. A safe as claimed in claim 1, configured for use in conjunction with an Automated Teller Machine.

8. A method of reconfiguring the direction of opening of a safe door, comprising the steps of
securing the safe door in a closed position such that the weight of the safe door will be borne by the safe,
connecting hinge parts on a first side of the door to form a hinge, and
removing hinge parts on a second side of the door.

9. A method according to claim 8, wherein the hinge parts are connected by inserting a hinge pin.

10. A method according to claim 9, wherein the hinge pins are secured in the hinge parts.

11. A method according to claim 8, further comprising the step of unsecuring the safe door.

12. A method according to claim 8, wherein prior to application of the method the safe door pivots open in a first direction, and after application of the method, the safe door pivots open in a second direction.

13-14. (canceled)
